(19) United States
(12) Patent Application Publication
(10) Pub. No.: US 2009/0115395 A1
(43) Pub. Date: May 7, 2009

(54) POWER SUPPLY SYSTEM

(75) Inventor: Chun-Wei Pan, Taoyuan Hsien (TW)

Correspondence Address: PAI PATENT & TRADEMARK LAW FIRM, 1001 FOURTH AVENUE, SUITE 3200, SEATTLE, WA, 98154, US

(73) Assignee: CHANNEL WELL TECHNOLOGY CO., LTD., Taoyuan Hsien (TW)

(21) Appl. No.: 12/142,785

(22) Filed: Jun. 20, 2008

(30) Foreign Application Priority Data
Nov. 5, 2007 (TW) 96218624

(51) Int. Cl. F02P 3/02

(52) U.S. Cl. 323/371

(57) ABSTRACT

A power supply system includes a power supply unit, a conductive wire group and a voltage converter. The conductive wire group consists of a numbers of wires and extends from the power supply unit to electrically connect the voltage converter. The voltage converter can electrically connect at least a working element. Therefore, a first supply voltage is provided from the power supply unit to the voltage converter via the wires, the voltage converter converts the first supply voltage into a second supply voltage for the working element.

### RELATED APPLICATIONS

This application claims priority to Taiwan Application Serial Number 96218624, filed Nov. 5, 2007, which is herein incorporated by reference.

### BACKGROUND

1. Field of Invention

This invention is related to a power supply system, and more particularly to a power supply system with a voltage converter separated from a power supply unit.

2. Description of Related Art

A traditional switching power supply for a desktop computer outputs multiple DC voltages in order to meet different DC voltage needs for different working elements performing in the desktop computer normally. Furthermore, the traditional switching power supply respectively connects those working elements with different conductive wires and different interface formats based on the interface format that each working element adopts.

For example, a 750 W switching power supply has 76 conductive wires with different interface formats to connect to the following working elements:

26 conductive wires with Interface “20+4 PINS” for Motherboard;

8 conductive wires with Interface “8 PINS to 4 PINS” for CPU;

24 conductive wires with Interface “PCI-6 pin ×4” for 2 sets of Advanced Graphics Card;

8 conductive wires with Interface “Advanced Technology Attachment (ATA)” for one type of DISC Drivers; and

10 conductive wires with interface “Serial ATA (SATA) for another type of DISC Drivers”.

Note however that such a high quantity of conductive wires with multiple interface formats in the desktop computer will cause a lot of inconvenience and trouble, such as the follows:

1. When the desktop computers are assembled in mass production, great quantity of conductive wires are time-consuming to assemble, and are complicated to be contained in the desktop computer; and

2. Before the desktop computers are assembled in mass production, the multiple interface formats of the conductive wires burdens the task of preparing the materials stock of the conductive wires, and of course the task significantly increases production time cost, labor cost and material cost for the desktop computer assembly industries.

In view of the desktop computer with better performances in the future, the switching power supply must enhance higher power supply in capability to provide the future desktop computer. Therefore, the related industries must overcome the mentioned inconvenience and trouble, and develop an improved power supply system to simplify the quantity of the conductive wires base on enough power supply.

### SUMMARY

It is therefore an objective of the present invention to present power supply system whereby the quantity of the conductive wires will be simplified and the production time and cost of the conductive wires will be reduced.

To achieve the foregoing objectives, the present invention provides a power supply system comprises a power supply unit, a voltage converter and at least a conductive wire group. The voltage converter is electrically connected to a working element (e.g. motherboard and graphic driving card) and the conductive wire group has a plurality of wires in which each of the wires extends from the power supply unit and electrically connects to the voltage converter. Therefore, when the power supply unit outputs a first supply voltage to the voltage converter via the wires, the voltage converter converts the first supply voltage into a second supply voltage for the working element to operate normally.

The invention also provides another power supply system. The power supply system comprises a power supply unit, a circuit board at least having a voltage conversion circuit thereon, and a conductive wire group having a plurality of wires. Each wire extends from the power supply unit and electrically connects to the voltage conversion circuit. Therefore, when the power supply unit outputs a first supply voltage to the circuit board via the wires, the voltage conversion circuit converts the first supply voltage into a second supply voltage for the circuit board for operation.

The key featured technique of the present invention is to place the voltage converter (or voltage conversion circuit) close to the working element (including mother board), and shorten the distance between the voltage converter (or voltage conversion circuit) and the working element (including mother board). Therefore, the invention not only provides a stable power supply preventing from signal weakness, but also saves production time, labor cost and material cost by reducing the quantity of conductive wires.

### BRIEF DESCRIPTION OF THE DRAWINGS

The structure and the technical means adopted by the present invention to achieve the above and other objectives can be best understood by referring to the following detailed description of the preferred embodiments and the accompanying drawings, where:

FIG. 1 is a schematic view of the power supply system according to a first embodiment of the present invention;

FIG. 2 is a function block of a power supply unit according to the first embodiment of the present invention;

FIG. 3 is another schematic view of the power supply system according to the first embodiment of the present invention;

FIG. 4 is a schematic view of the power supply system according to a second embodiment of the present invention;

FIG. 5 is a schematic view of the power supply system according to a third embodiment of the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Most of the electrical apparatus (e.g. TVs, Stereo and computers etc.) only work by power supply in direct current (D.C.), and some electric components in the electrical apparatus even operate at different voltages. Therefore, the power supply (e.g. city electricity with alternating current, AC) with an original voltage must be moderated up or down to a desired voltage by the electrical apparatus to be a normally operating power supply.

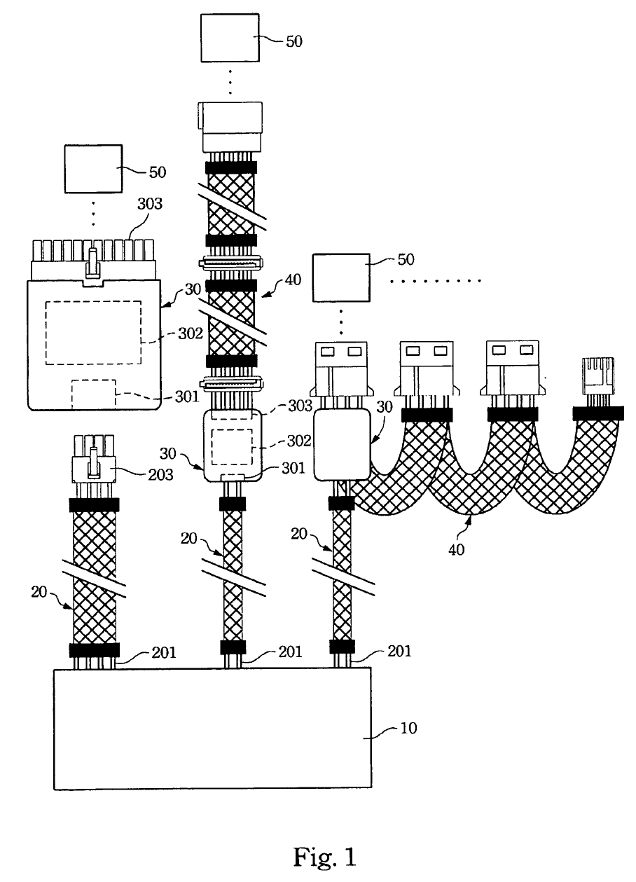

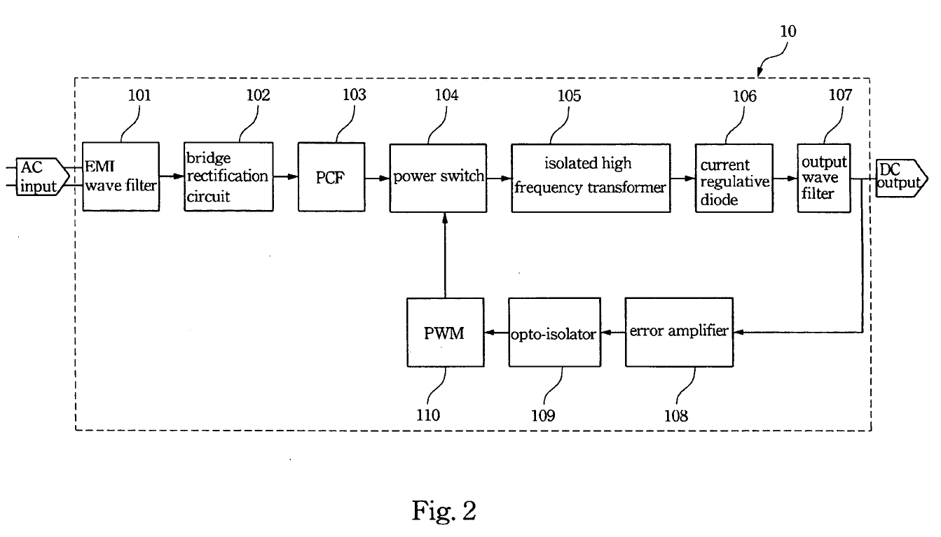

Refer to FIG. 1. FIG. 1 is a schematic view of the power supply system according to a first embodiment of the present invention. This present invention discloses a power supply system for a computer apparatus (e.g. personal computer or industrial personal computer) in which a power supply unit 10 of the power supply system provides diversified voltages for a number of working elements 50 such as a motherboard, disk drive etc. in the computer apparatus. Refer to FIG. 2. More detailed introduction of the power supply unit 10 is shown in FIG. 2, a function block of the power supply unit according to the first embodiment.

The power supply unit 10 comprises an EMI wave filter 101, a bridge rectification circuit 102, a power factor adjustment circuit (PFC) 103, a power switch 104, an isolated high frequency transformer 105, current regulative diode 106, output wave filter 107, an error amplifier 108, opto-isolator 109, and a pulse width modulation (PWM) 110. The EMI wave filter 101 prevents the power supply unit 10 from conducted electromagnetic noise interference. The bridge rectification circuit 102 transforms the inputted AC power supply into the DC power supply. The PFC 103 adjusts the power factors of the DC power supply to meet an environmental protection criterion. The PWM 110 controls whether the power switch 104 is on or off.

While the power switch 104 is on, the DC power supply will be provided to a primary winding of the isolated high frequency transformer 105, and the DC current in the primary winding of the isolated high frequency transformer 105 will ascend gradually and be stored in the primary winding of the isolated high frequency transformer 105. Simultaneously, the DC current will be induced on a secondary winding thereof. Thus, the current regulative diode 106 will convert the DC voltage, and the DC voltage. On the other hand, while the power switch 104 is not continuously conducted, the DC current stored in the primary winding will be moved to the secondary winding thereof. Lastly, after the error amplifier 108 comparing a part of the DC voltage with a voltage reference, the error amplifier 108 will obtain an error value and the error value will help the PWM 110 to determine the time that the power switch 104 continuously conducts, by modulating the pulse width of the DC voltage.

Refer to FIG. 1 again. The power supply unit 10 respectively electrically connects to one of the different working elements 50 with a conductive wire group 20. Each conductive wire group 20 consists of a plurality of wires 201 that extends from the power supply unit 10 to connect a voltage converter 30. In the first embodiment, the conductive wire group 20 only has two or four pieces of wires 201, wherein at least two of the wires 201 are respectively coupled to a positive electrode and a negative electrode of the power supply unit 10, another two wires 201 are respectively used for transmitting initiated signals (+5 Vsb), and booting feedback signals (PS/ON). Each end of the wires 201 of the conductive wire group 20 that connect to the voltage converter 30 can be coupled in a connector 203, thus, the wires 201 of the conductive wire group 20 can electrically connect to the voltage converter 30 through the connector 203. Thus, compared with the traditional switching power supply having at least 19 wires 201, the quantity (i.e. 2 or 4) of the wires 201 in each of the conductive wire group 20 in the present invention has been reduced to save the production time, labor cost and material cost.

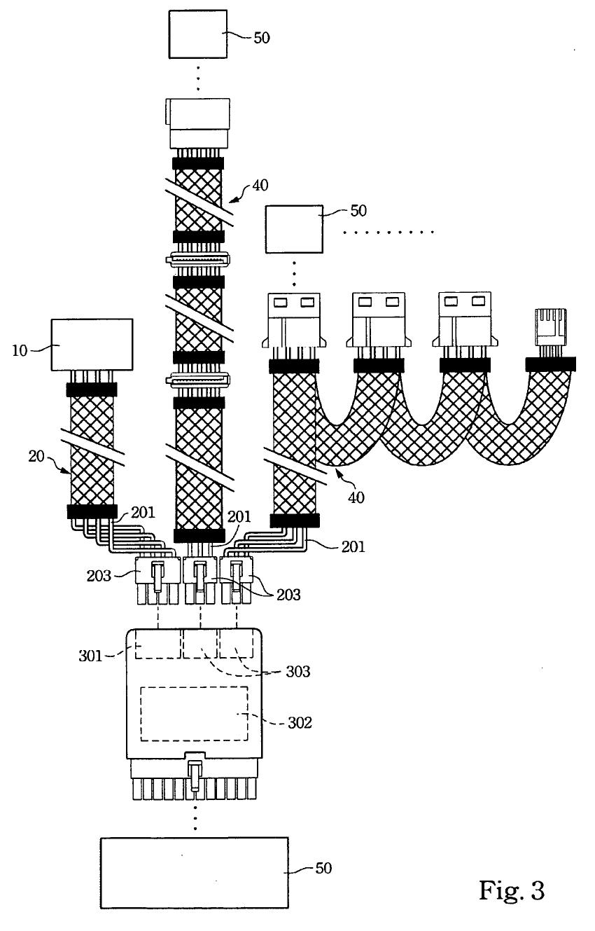

Refer to FIG. 1 and FIG. 3. FIG. 3 is another schematic view of the power supply system according to the first embodiment of the present invention. The voltage converter 30 in the first embodiment can be presented as an independent apparatus having its own case, and the independent apparatus is separated from the power supply unit 10. This independent apparatus comprises a DC input terminal 301, a voltage converting portion 302 and at least one DC output terminal 303. The voltage converting portion 302 respectively electrically connects to the DC input terminal 301 and each DC output terminal 303, and the DC input terminal 301 electrically connects the connector 203. If more than one DC output terminal 303 exist in the independent apparatus, one DC output terminal 303 called a first DC output terminal 303 has at least 20 (or 24) conductive pins to electrically connect a motherboard, and another DC output terminal 303 called a second DC output terminal 303 has at least 3 conductive pins to electrically connect a disk driver with an “Advanced Technology Attachment (ATA)” interface format or “Serial ATA (SATA)” interface format.

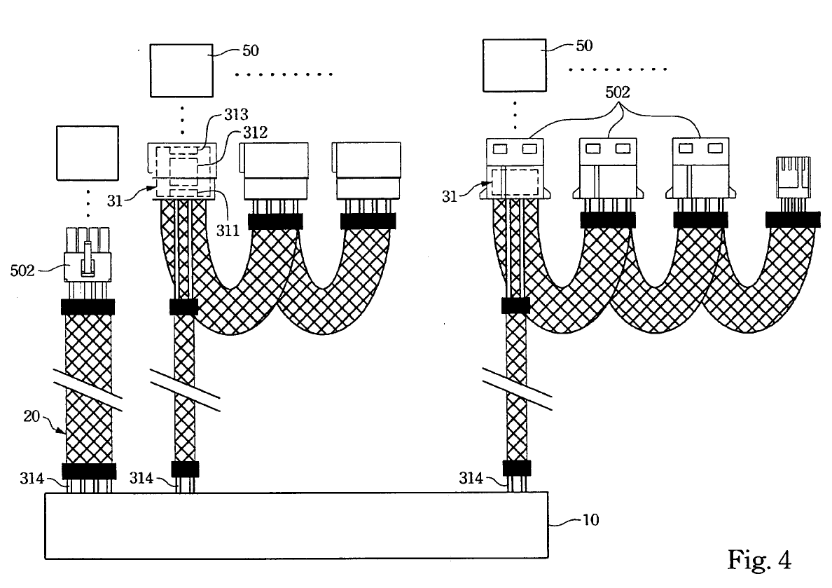

Refer to FIG. 4. FIG. 4 is a schematic view of the power supply system according to a second embodiment of the present invention. The voltage converter 30 in the second embodiment can be presented as a voltage conversion circuit 31 integrated in a connector 502. The connector 502 can be movably electrically connected to a motherboard or a disk driver with an “Advanced Technology Attachment (ATA)” interface format or “Serial ATA (SATA)” interface format. The voltage conversion circuit 31 converts a first supply voltage into a second supply voltage to be the operating power supply for the working element 50, once the connector 502 is electrically connected to the working element 50 (e.g. motherboard and disk driver).

The voltage conversion circuit 31 has a DC input terminal 311, a voltage converting portion 312 and at least one DC output terminal 313. The DC input terminal 311 electrically connects to the wires 314 and receives the first supply voltage from the power supply unit 10. The DC output terminal 313 electrically connects one of the working elements 50. The voltage converting portion 312 separately electrically connects with the DC input terminal 311 and the DC output terminal 313, and the voltage converting portion 312 increases or reduces the received first supply voltage from the DC input terminal 311 into a second supply voltage to the DC output terminal 313.

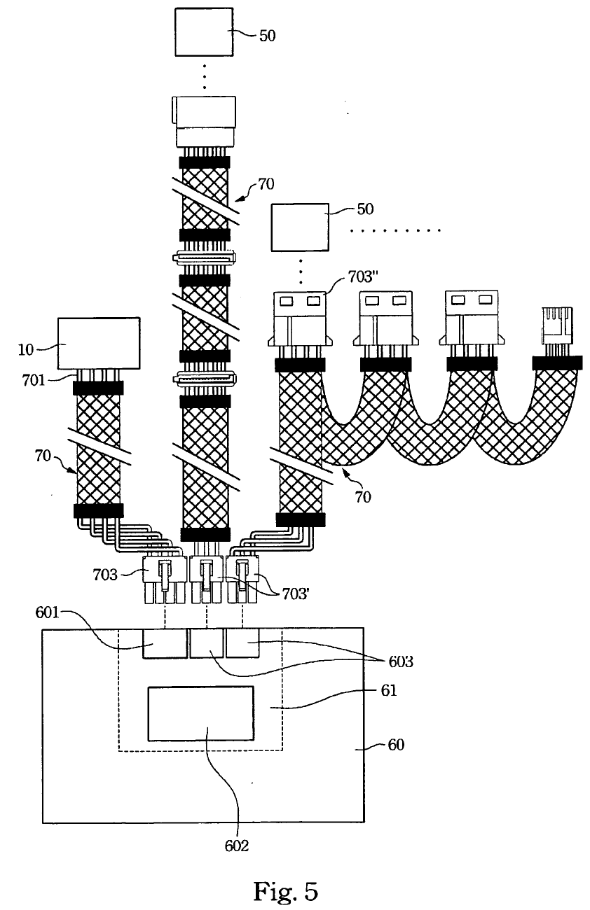

Refer to FIG. 5. FIG. 5 is a schematic view of the power supply system according to a third embodiment of the present invention. The voltage converter 30 in the third embodiment can be a voltage conversion circuit 61 integrated on a part of a circuit board 60 such as a motherboard or an interface card. The voltage conversion circuit 61, which converts the first voltage into the second voltage, comprises a DC input terminal 601, a voltage converting portion 602 and at least one DC output terminal 603. The DC input terminal 601 can be movably electrically connected to a connector 703 which couples the ends of the wires 701 of one conductive wire groups 70, and the DC input terminal 601 can receive the first supply voltage from the power supply unit 10.

The voltage converting portion 602 can be electrically connected to the DC input terminal 601 and each DC output terminal 603, and the voltage converting portion 602 can increase or reduce the received first supply voltage from the DC input terminal 601 into a second supply voltage to the circuit board 60 for an operating power supply.

Each of the DC output terminals 603 can be movably electrically connected one working element 50 (e.g. disk drivers, graphic card) via wires 701 of another conductive wire groups 70, and provide the second supply voltage to the corresponding working element 50. The wires 701 of another conductive wire groups 70 between the DC output terminals 603 and the corresponding working element 50, has one end thereof being coupled in another connector 703′ for the DC output terminal 603, and has another end thereof being coupled in the other connector 703″ for the corresponding working element 50. The other connector 703″ conforms to “Advanced Technology Attachment (ATA)” interface format or “Serial ATA (SATA)” interface format.

In conclusion, the invention provides a conception that separating the voltage converter 30 (or voltage conversion circuit 31, 61) from the power supply 10, and shortening the distance between the voltage converter 30 (or voltage conversion circuit 31, 61) and the working element 50. The conception simplifies the sorts of outputting voltages (+5 Vsb, +12V, and PS/ON) from the power supply 10, rather than the sorts of voltages (+5V, +3.3V, +5 Vsb, −12V, +12V and PS/ON) outputted from the traditional switching power supply, and reduces the quantity of the wires 201,701, and 314 between the voltage converter 30 (or voltage conversion circuit 31, 61) and power supply 10. Therefore, the invention of course cuts down the cost of labor and wire materials.

Although the present invention has been described in considerable detail with reference in the certain preferred embodiments thereof, other embodiments do not only limit the number of the wires and the conductive pins to the mentioned information above. The number of the wires and the conductive pins can be modified based on the realistic demands. Therefore, the spirit and scope of the appended claims should not be limited to the description of the preferred embodiments contained herein.

What is claimed is:

1. A power supply system, comprising:
a power supply unit;
a voltage converter capable of electrically connecting at least a working element; and
at least a conductive wire group having a plurality of wires, each of the wires extending from the power supply unit and electrically connecting to the voltage converter,
wherein the power supply unit outputs a first supply voltage to the voltage converter via the wires, and the voltage converter converts the first supply voltage into a second supply voltage for the working element.

2. The power supply system as claimed in claim 1, wherein the voltage converter is an apparatus separated from the power supply unit, and the voltage converter comprises:
a DC input terminal electrically connected to the wires and capable of receiving the first supply voltage from the power supply unit;
at least one DC output terminal capable of electrically connecting one of the working elements ; and
a voltage converting portion separately electrically connecting with the DC input terminal and the at least one DC output terminal, and capable of increasing or reducing the received first supply voltage from the DC input terminal to the at least one DC output terminal.

3. The power supply system as claimed in claim 2, wherein the at least one DC output terminal has at least 20 conductive pins to electrically connect a motherboard.

4. The power supply system as claimed in claim 2, wherein at least one DC output terminal is capable of electrically connecting a disk driver which has an “Advanced Technology Attachment” interface format or “Serial ATA” interface format.

5. The power supply system as claimed in claim 1, wherein the voltage converter is a voltage conversion circuit, comprises:
a DC input terminal electrically connected to the wires and capable of receiving the first supply voltage from the power supply unit;
at least one DC output terminal capable of electrically connecting one of the working elements; and
a voltage converting portion separately electrically connecting with the DC input terminal and the at least one DC output terminal, and capable of increasing or reducing the received first supply voltage from the DC input terminal to the at least one DC output terminal.

6. The power supply system as claimed in claim 5, wherein the voltage conversion circuit is integrated in a connector, and the connector is capable of electrically connecting the working element that the at least one DC output terminal connects to.

7. The power supply system as claimed in claim 6, wherein the connector is capable of electrically connecting a motherboard, or a disk driver having an interface conforming to “Advanced Technology Attachment” format or “Serial ATA” format.

8. The power supply system as claimed in claim 1, wherein two of the wires respectively coupled to a positive electrode and a negative electrode of the power supply unit.

9. A power supply system, comprising:
a power supply unit;
a circuit board at least having a voltage conversion circuit thereon; and
a conductive wire group having a plurality of wires, each of the wires extending from the power supply unit and electrically connecting to the voltage conversion circuit,
wherein the power supply unit outputs a first supply voltage to the circuit board via the wires, and the voltage conversion circuit converts the first supply voltage into a second supply voltage for the circuit board.

10. The power supply system as claimed in claim 9, wherein the voltage conversion circuit comprises:
a DC input terminal electrically connected to the wires and capable of receiving the first supply voltage from the power supply unit; and
a voltage converting portion electrically connecting with the DC input terminal, and capable of increasing or reducing the received the first supply voltage from the DC input terminal to the circuit board.

11. The power supply system as claimed in claim 10, wherein the voltage conversion circuit further comprises at least one DC output terminal that electrically connects one working element and provides the second supply voltage to the working element.

12. The power supply system as claimed in claim 11, wherein the connector is capable of electrically connecting a disk driver having an interface conforming to “Advanced Technology Attachment” format or “Serial ATA” format.

13. The power supply system as claimed in claim 11, wherein two wires of the conductive wire group respectively coupled to a positive electrode and a negative electrode of the power supply unit.
